(19) United States
(12) Patent Application Publication
(10) Pub. No.: US 2018/0334217 A1
(43) Pub. Date: Nov. 22, 2018

(54) HANDLEBAR ADJUSTING DEVICE OF BICYCLE

(71) Applicant: Mu-Rong Li, Taichung City (TW)

(72) Inventor: Mu-Rong Li, Taichung City (TW)

(21) Appl. No.: 15/600,800

(22) Filed: May 22, 2017

(51) Int. Cl. B62K 21/22

(52) U.S. Cl. CPC B62K 21/22

(57) ABSTRACT

A handlebar adjusting device includes a handlebar stem having a top hole for being connected to a steering tube, and an elongate lateral hole for being connected to a handlebar. An adapter is located in the lateral hole and contacts the handlebar. An urging unit is located in the lateral hole and includes a middle piece, a first piece, a second piece and a bolt. The middle piece has two inclined faces in two ends thereof. The two inclined faces respectively contact the first and second pieces. The bolt extends through the first piece, the two inclined faces of the middle piece and is connected to the second piece. When the bolt is rotated, the first and second pieces move to press against the two inclined faces which is moved radially in the lateral hole to push the adapter to position the handlebar.

### BACKGROUND OF THE INVENTION

### 1. Fields of the Invention

The present invention relates to a handlebar adjusting device of a bicycle, and more particularly, to a handlebar stem that allows the users to adjust the position of the handlebar relative to the steering tube.

### 2. Descriptions of Related Art

The conventional handlebar stem generally comprises a first end for being connected with the handlebar, and a second end for being connected to the steering tube, and the distance between the handlebar and the steering tube cannot be adjusted. Nevertheless, the distance between the handlebar and the steering tube may affect the operation of the users of different sizes. Most of the handlebar stems known to applicant can only adjust the angle of the handlebar relative to the handlebar stem. There are multiple bolts are involved to secure the handlebar, when the handlebar is to be adjusted, the users have to unscrew the bolts to set the handlebar at the desired position, and then fastening the bolts again. These processes are complicated and take a long time. Besides, there are extra parts needed to secure the handlebar.

The present invention intends to provide a handlebar stem that is designed to adjust the position of the handlebar relative to the steering tube.

### SUMMARY OF THE INVENTION

The present invention relates to a handlebar adjusting device and comprises a handlebar stem having a first end and a second end. A top hole is defined axially in the top of the first end of the stem, and the top hole is mounted to a steering tube. A lateral hole is defined axially through two sides of the second end of the stem, and the lateral hole is an elongate hole and has a first inner end and a second inner end. The lateral hole is mounted to a handlebar. An adapter is located in the lateral hole and contacts the handlebar. An urging unit is located in the lateral hole and has a middle piece, a first piece, a second piece and a bolt. The middle piece has two inclined faces defined in two ends thereof. The two inclined faces respectively contact the first and second pieces, and the bolt extends through the first piece, the two inclined faces of the middle piece and is connected to the second piece.

When the bolt is rotated to pull the second piece toward the bolt, the first and second pieces move to press against the two inclined faces of the middle piece which is moved radially in the lateral hole to push the adapter which positions the handlebar.

The present invention provides a second embodiment of the handlebar adjusting device which comprises a handlebar stem having a first end and a second end. A top hole is defined axially in the top of the first end of the stem. The top hole is mounted to a steering tube. A lateral hole is defined axially through two sides of the second end of the stem. The lateral hole is an elongate hole and has a first inner end and a second inner end. The lateral hole is mounted to a handlebar. An adapter is located in the lateral hole and between the first inner end or the second inner end, and the handlebar. The adapter contacts the handlebar. An urging unit is located in the lateral hole and between the first inner end or the second inner end, and the handlebar. The handlebar is located between the adapter and the urging unit. The adapter and the urging unit contact the handlebar. The urging unit has a middle piece, a first piece, a second piece and a bolt. The middle piece has two inclined faces defined in two ends thereof The two inclined faces respectively contact the first and second pieces. The bolt extends through the first piece, the two inclined faces of the middle piece and is connected to the second piece. When the bolt is rotated to pull the second piece toward the bolt, the first and second pieces move to press against the two inclined faces. The middle piece is moved radially in the lateral hole to push the adapter which positions the handlebar.

The primary object of the present invention is to provide a handlebar adjusting device wherein the user adjusts the position of the handlebar by simply operating one bolt.

The present invention will become more apparent from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the handlebar adjusting device of the present invention;

FIG. 2 is an exploded view of the handlebar adjusting device of the present invention;

FIG. 3 is a cross sectional view, taken along line III-III of FIG. 1;

FIG. 4 is a cross sectional view, taken along line IV-IV of FIG. 1;

FIG. 5 shows the operation of the urging unit of the handlebar adjusting device of the present invention;

FIG. 6 shows that the urging unit and the adapter located at the second inner end of the lateral hole of the stem;

FIG. 7 is a cross sectional view of the second embodiment of the handlebar adjusting device of the present invention, and

FIG. 8 is another cross sectional view of the second embodiment of the handlebar adjusting device of the present invention.

### DETAILED DESCRIPTION OF THE PREFERRED EMBODIMENT

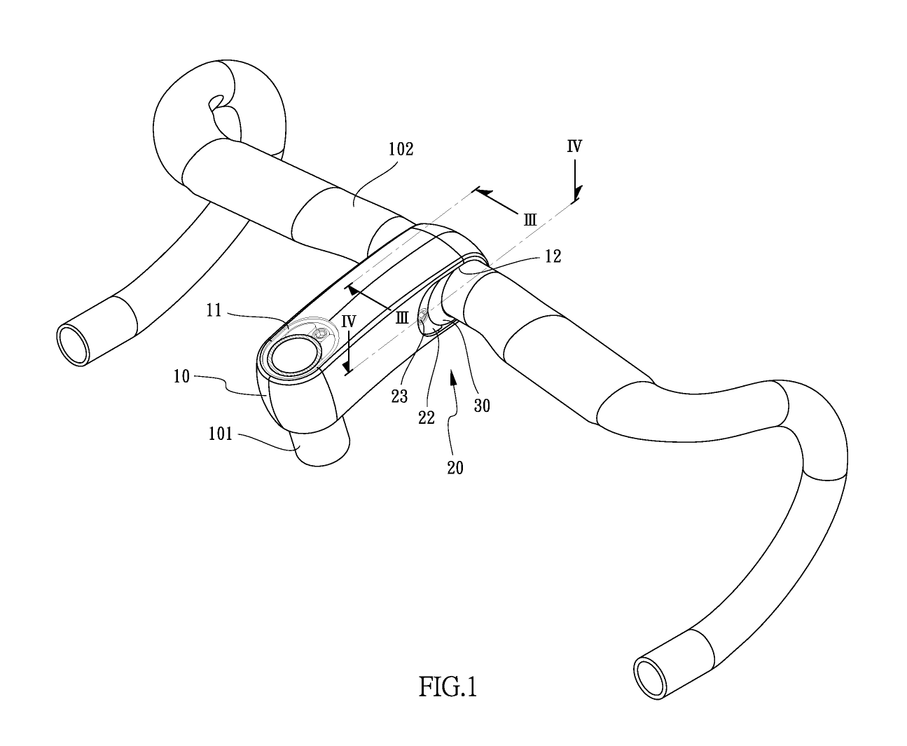

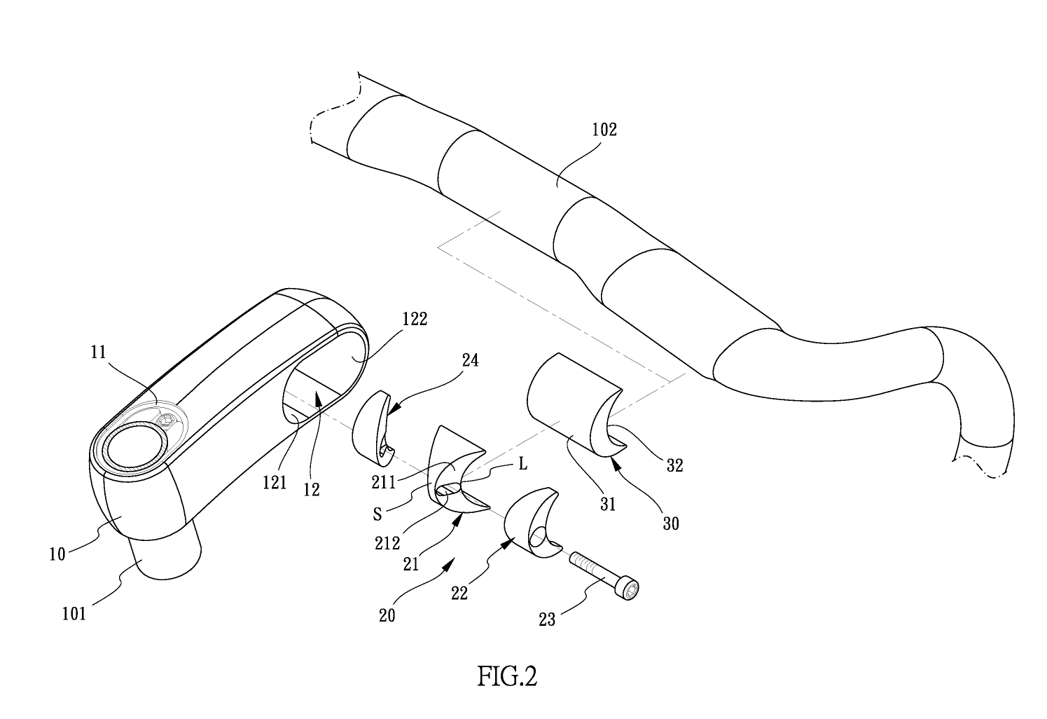

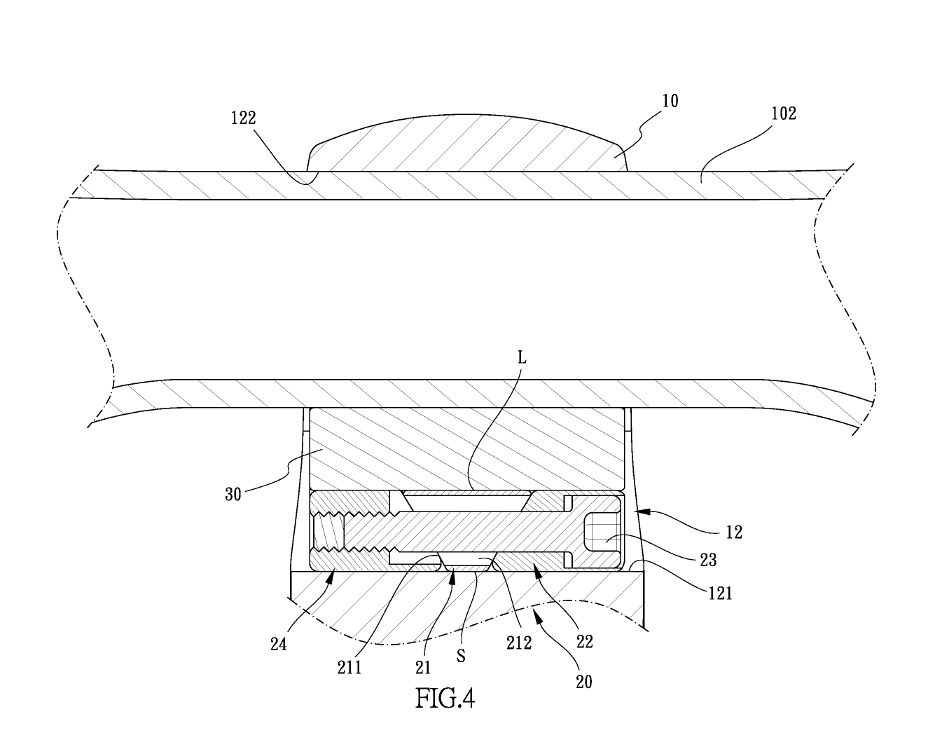

Referring to FIGS. 1 to 6, the handlebar adjusting device of the present invention comprises a handlebar stem 10 having a first end and a second end. A top hole 11 is defined axially in the top of the first end of the stem 10. The top hole 11 is mounted to a steering tube 101. A lateral hole 12 is defined axially through two sides of the second end of the stem 10. The lateral hole 12 is an elongate hole and has a first inner end 121 and a second inner end 122, wherein the first inner end 121 is located close to the steering tube 101, and the second inner end 122 is located away from the steering tube 101. The lateral hole 12 is mounted to a handlebar 102. An adapter 30 is located in the lateral hole 12 and contacts the handlebar 102.

An urging unit 20 is located in the lateral hole 12 and has a middle piece 21, a first piece 22, a second piece 24 and a bolt 23. The middle piece 21 has two inclined faces 211 defined in two ends thereof, and the two inclined faces 211 respectively contact the first and second pieces 22, 24. The bolt 23 extends through the first piece 22, the two inclined faces 211 of the middle piece 21 and is connected to the second piece 24. When the bolt 23 is rotated to pull the second piece 24 toward the bolt 23, the first and second pieces 22, 24 move to press against the two inclined faces 211, and the middle piece 21 is moved radially in the lateral hole 12 to push the adapter 30 which positions the handlebar 102.

As shown in FIGS. 1 to 8, the adapter 30 includes a convex face 31 and a concave face 32 which is located opposite to the convex face 31. The middle piece 21 includes a through hole 212 which extends through the two inclined faces 211. The through hole 212 is an elongate hole defined transversely through the middle piece 21. The inner diameter of the through hole 212 is larger than the outer diameter of the bolt 23.

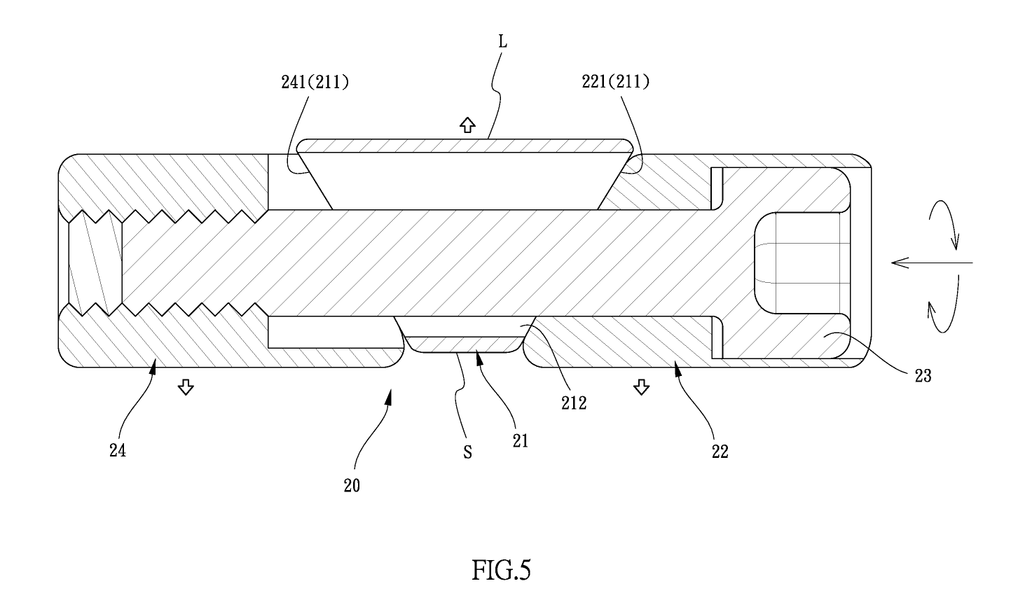

As shown in FIG. 5, each of the two inclined faces 211 of the middle piece 21 includes a short face “S” and a long face “L” which is located opposite to the short face “S”. The first piece 22 has a first guide face 221, and the second piece 24 has a second guide face 241. The first and second guide faces 221, 241 respectively contact the two inclined faces 211. When the bolt 23 is rotated to pull the second piece 24 toward the bolt 23, the first and second pieces 22, 24 move toward the short face “S”, and the middle piece 21 moves toward the long face “L” as indicated by the hollow arrowhead. When the bolt 23 is rotated to push the second piece 24 away from the bolt 23, the first and second pieces 22, 24 move toward the long face “L”, and the middle piece 21 moves toward the short face “S”. That is to say, the handlebar 102 is adjusted by only operating one bolt 23.

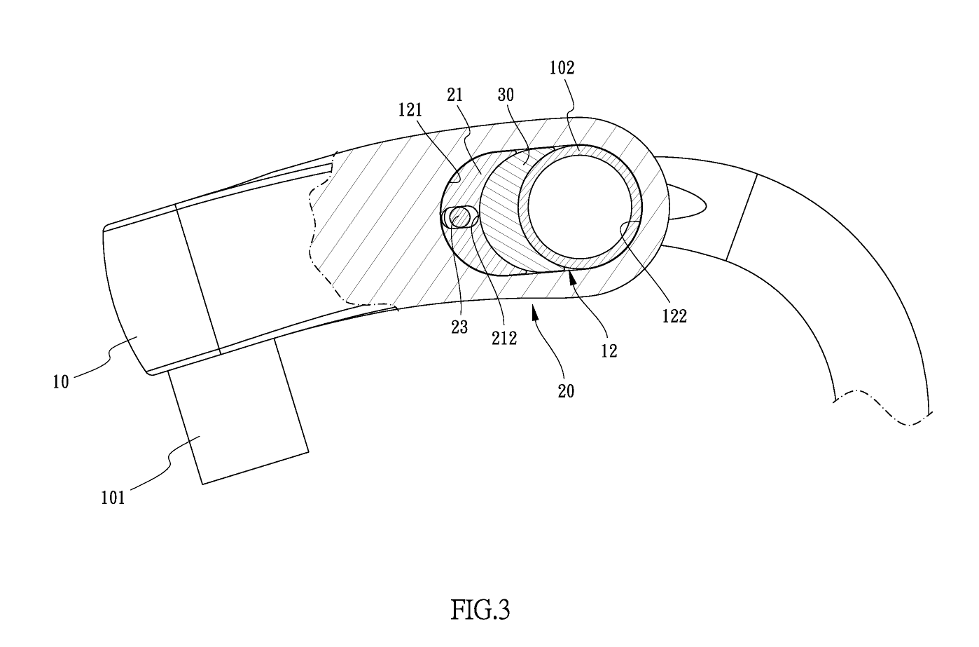

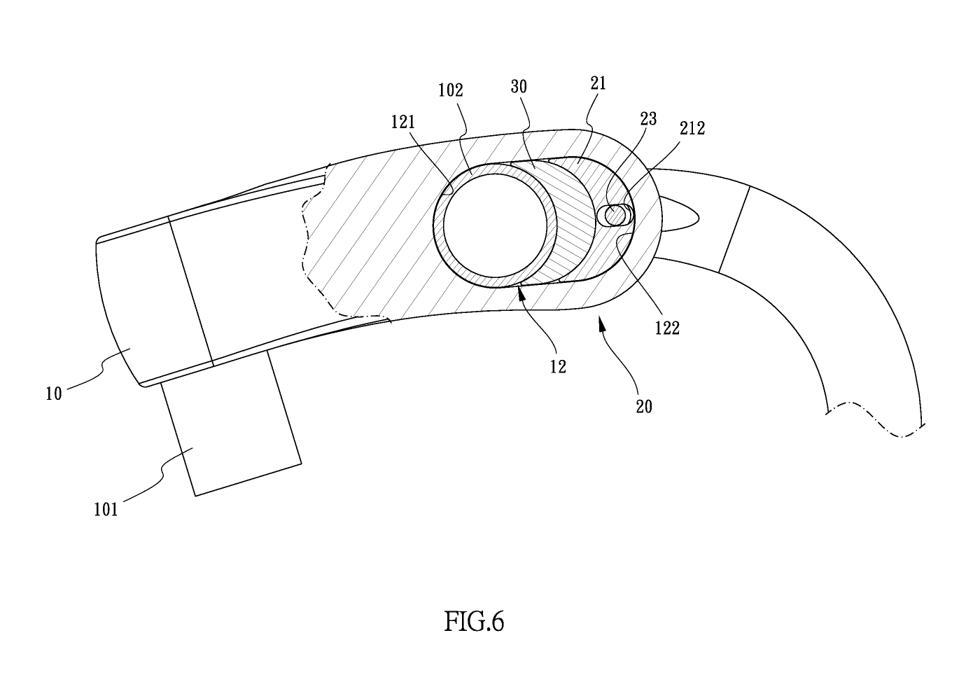

As shown in FIG. 6, the positions of the urging unit 20 and the adapter 30 are changed from the positions in FIG. 3 to the positions as disclosed in FIG. 6. The urging unit 20 and the adapter 30 are located between the second inner end 122 and the handlebar 102, the handlebar 102 is adjusted to move toward the steering tube 101.

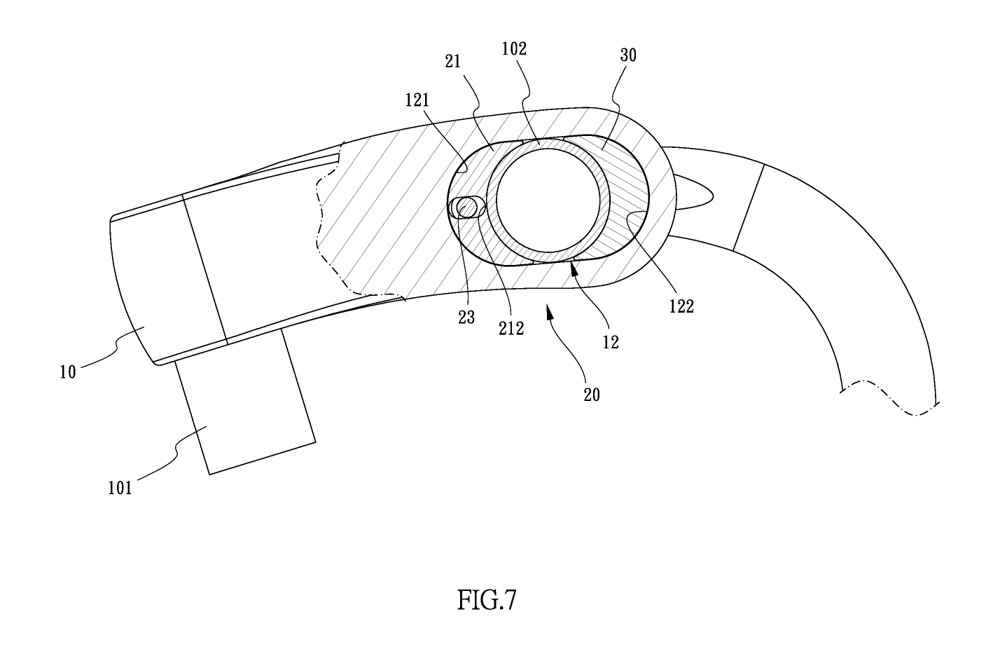

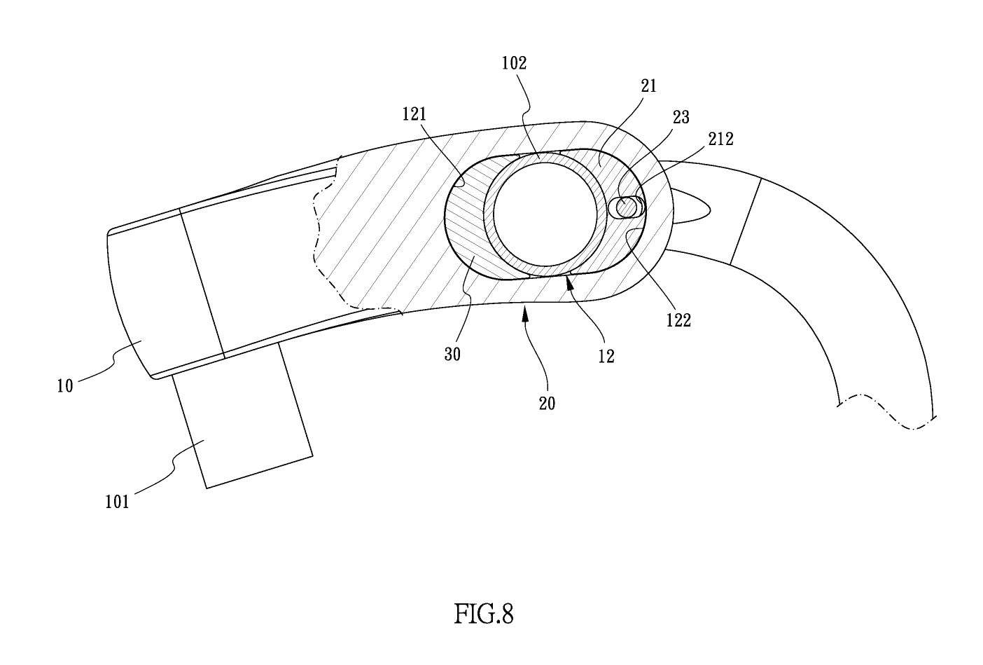

FIGS. 7 and 8 show the second embodiment of the present invention, wherein the adapter 30 located in the lateral hole 12 and between the first inner end 121 or the second inner end 122, and the handlebar 102, and the adapter 30 contacts the handlebar 102.

The urging unit 20 is located in the lateral hole 12 and between the first inner end 121 or the second inner end 122, and the handlebar 102. The handlebar 102 is located between the adapter 30 and the urging unit 20. The adapter 30 and the urging unit 20 contact the handlebar 102.

The advantages of the present invention are that by arranging the adapter 30 located in the lateral hole 12 and between the first inner end 121 or the second inner end 122, and the handlebar 102, the handlebar 102 can be adjusted in the lateral hole 12.

The users only operates the bolt 23 to tighten or loosen the handlebar 102 relative to the lateral hole 12. This is convenient and efficient when compared with the conventional handlebar adjusting devices.

What is claimed is:

1. A handlebar adjusting device comprising:
a handlebar stem (10) having a first end and a second end, a top hole (11) defined axially in a top of the first end of the stem (10), the top hole (11) mounted to a steering tube (101), a lateral hole (12) defined axially through two sides of the second end of the stem (10), the lateral hole (12) being an elongate hole and having a first inner end (121) and a second inner end (122), the lateral hole (12) mounted to a handlebar (102);
an adapter (30) located in the lateral hole (12) and contacting the handlebar (102), and
an urging unit (20) located in the lateral hole (12) and having a middle piece (21), a first piece (22), a second piece (24) and a bolt (23), the middle piece (21) having two inclined faces (211) defined in two ends thereof, the two inclined faces (211) respectively contacting the first and second pieces (22, 24), the bolt (23) extending through the first piece (22), the two inclined faces (211) of the middle piece (21) and connected to the second piece (24), when the bolt (23) is rotated to pull the second piece (24) toward the bolt (23), the first and second pieces (22, 24) move to press against the two inclined faces (211) which is moved radially in the lateral hole (12) to push the adapter (30) which positions the handlebar (102).

2. The handlebar adjusting device as claimed in claim 1, wherein the adapter (30) includes a convex face (31) and a concave face (32) which is located opposite to the convex face (31).

3. The handlebar adjusting device as claimed in claim 1, wherein the middle piece (21) includes a through hole (212) which extends through the two inclined faces (211), the through hole (212) is an elongate hole defined transversely through the middle piece (21), an inner diameter of the through hole (212) is larger than an outer diameter of the bolt (23).

4. The handlebar adjusting device as claimed in claim 2, wherein the middle piece (21) includes a through hole (212) which extends through the two inclined faces (211), an inner diameter of the through hole (212) is larger than an outer diameter of the bolt (23).

5. The handlebar adjusting device as claimed in claim 1, wherein each of the two inclined faces (211) of the middle piece (21) includes a short face and a long face which is located opposite to the short face, the first piece (22) has a first guide face (221) and the second piece (24) has a second guide face (241), the first and second guide faces (221, 241) respectively contact the two inclined faces (211), when the bolt (23) is rotated to pull the second piece (24) toward the bolt (23), the first and second pieces (22, 24) move toward the short face, and the middle piece (21) moves toward the long face, when the bolt (23) is rotated to push the second piece (24) away from the bolt. (23), the first and second pieces (22, 24) move toward the long face, and the middle piece (21) moves toward the short face.

6. A handlebar adjusting device comprising:
a handlebar stem (10) having a first end and a second end, a top hole (11) defined axially in a top of the first end of the stem (10), the top hole (11) mounted to a steering tube (101), a lateral hole (12) defined axially through two sides of the second end of the stem (10), the lateral bole (12) being an elongate hole and having a first inner end (121) and a second inner end (122), the lateral hole (12) mounted to a handlebar (102);
an adapter (30) located in the lateral hole (12) and between the first inner end (121) or the second inner end (122), and the handlebar (102), the adapter (30) contacting the handlebar (102), and
an urging unit (20) located in the lateral hole (12) and between the first inner end (121) or the second inner end. (122), and the handlebar (102), the handlebar (102) located between the adapter (30) and the urging unit (20), the adapter (30) and the urging unit (20) contacting the handlebar (102), the urging unit (20) having a middle piece (21), a first piece (22), a second piece (24) and a bolt (23), the middle piece (21) having two inclined faces (211) defined in two ends thereof, the two inclined faces (211) respectively contacting the first and second pieces (22, 24), the bolt (23) extending through the first piece (22), the two inclined faces (211) of the middle piece (21) and connected to the second piece(24), when the bolt (23) is rotated to pull the second piece (24) toward the bolt (23), the first and second pieces (22, 24) move to press against the two inclined faces (211) which is moved radially in the lateral hole (12) to push the adapter (30) which positions the handlebar (102).

7. The handlebar adjusting device as claimed in claim 6, wherein the adapter (30) includes a convex face (31) and a concave face (32) which is located opposite to the convex face (31).

8. The handlebar adjusting device as claimed in claim 6, wherein the middle piece (21) includes a through hole (212) which extends through the two inclined faces (211), the through hole (212) is an elongate hole defined transversely through the middle piece (21), an inner diameter of the through hole (212) is larger than an outer diameter of the bolt (23).

9. The handlebar adjusting device as claimed in claim 7, wherein the middle piece (21) includes a through hole (212) which extends through the two inclined faces (211), an inner diameter of the through hole (212) is larger than an outer diameter of the bolt (23).

10. The handlebar adjusting device as claimed in claim 6, wherein each of the two inclined faces (211) of the middle piece (21) includes a short face and a long face which is located opposite to the short face, the first piece (22) has a first guide face (221) and the second piece (24) has a second guide face (241), the first and second guide faces (221, 241) respectively contact the two inclined faces (211), when the bolt (23) is rotated to pull the second piece (24) toward the bolt (23), the first and second pieces (22, 24) move toward the short face, and the middle piece (21) moves toward the long face, when the bolt (23) is rotated to push the second piece (24) away from the bolt (23), the first and second pieces (22, 24) move toward the long face, and the middle piece (21) moves toward the short face.
